(19) United States
(12) Patent Application Publication
(10) Pub. No.: US 2014/0172151 A1
(43) Pub. Date: Jun. 19, 2014

(54) NUMERICAL CONTROL DEVICE

(71) Applicants: Toshihiro Niwa, Chiyoda-ku (JP); Mitsumasa Sakurai, Chiyoda-ku (JP); Toshiaki Kurokawa, Chiyoda-ku (JP)

(72) Inventors: Toshihiro Niwa, Chiyoda-ku (JP); Mitsumasa Sakurai, Chiyoda-ku (JP); Toshiaki Kurokawa, Chiyoda-ku (JP)

(73) Assignee: MITSUBISHI ELECTRIC CORPORATION, Chiyoda-ku, Tokyo (JP)

(21) Appl. No.: 13/985,216

(22) PCT Filed: Dec. 17, 2012
(86) PCT No.: PCT/JP2012/082665

§ 371 Date: Aug. 13, 2013

(51) Int. Cl. G05B 19/19

(52) U.S. Cl. CPC G05B 19/19
USPC 700/186

(57) ABSTRACT

A numerical control device analyzes a machining program containing one or more unit machining programs and displays a process shape figure (141a, 144a) obtained by executing the unit machining program. The device includes a machining-program analyzing unit that analyzes the unit machining program and acquires process shape information having parameters containing tool information for obtaining the figure (141a, 144a) for the unit machining program, a process-shape-figure creating unit that acquires process shape data corresponding to the tool information and creates a process shape figure obtained by changing the process shape data based on the parameters, and a display processing unit that displays the machining program and the figure (141a, 144a) on a display unit. The display processing unit displays the figure (141a, 144a) that is aligned with a display position of the unit machining program on the display unit.

### FIELD

The present invention relates to a numerical control device.

### BACKGROUND

In general, a numerical control device uses a machining program created in advance and controls a machine tool and machines a workpiece according to a control command output from the machining program. Usually, in the numerical control device, a machining program creator and an operator of a machine are often different. The operator of the machine cannot always fully understand an intention of the machining program creator simply by looking at the machining program. Therefore, it is likely that the operator cannot grasp machining contents and work efficiency falls or the operator selects a machining program different from the intended machining program and performs wrong machining. Therefore, when the machining program is selected, the numerical control device displays image data and additional information of the machining program to facilitate a check of program contents and enable quick selection of a necessary NC (Numerical Control) machining program (see, for example, Patent Literatures 1 and 2).

The numerical control device disclosed in Patent Literature 1 stores, in a memory area same as a memory area for a comment sentences registered for each program name in an NC machine tool, image data such as shapes, positions, and the like of workpieces and jigs captured in advance by an image input device. When an NC machining program is selected, the numerical control device immediately displays, as a list, the image data together with program names and comment sentences of the NC machining program.

In the numerical control device disclosed in Patent Literature 2, a machining program display area for displaying a machining program and a window area are provided in a display. When a machining program is selected, the numerical control device displays machining program information such as a machining simulation and a machining shape corresponding to the selected machining program in the window area.

### CITATION LIST

### Patent Literature

Patent Literature 1: Japanese Patent Application Laid-open No. 4-251305
Patent Literature 2: Japanese Patent Application Laid-open No. 5-204438

### SUMMARY

### Technical Problem

However, in the technology disclosed in Patent Literature 1, there is a problem in that it is necessary to capture image data for each machining program and it takes labor and time for creation and registration of the image data. Further, there is a problem in that, when machining program contents are changed, it is necessary to capture image data again.

In the technology disclosed in Patent Literature 2, there is a problem in that it takes time to display, in the window area, machining program information such as a machining simulation and a machining shape corresponding to a machining program. Further, there is a problem in that a plurality of machining simulations corresponding to a plurality of machining programs cannot be displayed on the display and cannot be easily compared.

The present invention has been devised in view of the above and it is an object of the present invention to obtain a numerical control device that can save labor and time for creation and registration of image data for each machining program, reduce time for displaying machining program information such as a machining simulation and a machining shape corresponding to a machining program, and display a plurality of machining shape figures on a display.

### Solution to Problem

The present invention is directed to a numerical control device that achieves the object. The numerical control device analyzes a machining program containing one or more unit machining programs and displays a process shape figure obtained by executing the unit machining program. The numerical control device includes a machining-program analyzing unit that analyzes the unit machining program in the machining program and acquires process shape information having parameters containing tool information for obtaining the process shape figure for the unit machining program, a process-shape-figure creating unit that acquires process shape data corresponding to the tool information in the process shape information and creates a process shape figure obtained by changing the process shape data based on the parameters in the process shape information, and a display processing unit that displays the machining program and the process shape figure on a display unit. The display processing unit displays the process shape figure that is aligned with a display position of the unit machining program of the machining program displayed on the display unit.

### Advantageous Effects of Invention

According to the present invention, the process shape information including the tool information is described in the machining program, the process shape data corresponding to the tool information is acquired, the tool shape figure obtained by changing the tool shape data based on the parameters in the process shape information is created, and the tool shape figure is displayed on the display unit while being associated with the machining program. Therefore, there is an effect that it is possible to display, in association with the machining program, the process shape figure obtained by executing the unit machining program including the process shape information of the machining program on the display unit without performing a simulation based on a machining command and easily grasp machining contents of the machining program.

### BRIEF DESCRIPTION OF DRAWINGS

FIG. 1 is a schematic block diagram of a functional configuration of a numerical control device according to a first embodiment.

FIG. 2 is a diagram showing an example of a machining program according to the first embodiment.

FIG. 3 is a diagram of an example of process shape data.

FIG. 4 is a flowchart for explaining an example of a display processing procedure for a process shape figure according to the first embodiment.

FIG. 5 is a diagram of an example of the process shape data processed in the first embodiment.

FIG. 6 is a schematic diagram of an example of processing for changing a rendering view point of the process shape data.

FIG. 7 is a diagram of an example of a state in which the machining program is caused to display the process shape data.

FIG. 8 is a schematic block diagram of a functional configuration of a numerical control device according to a second embodiment.

FIG. 9 is a diagram of an example of a state in which a machining program according to the second embodiment is caused to display process shape data.

FIG. 10 is a schematic block diagram of a functional configuration of a numerical control device according to a third embodiment.

FIG. 11 is a diagram of an example of a state in which a machining program according to the third embodiment is caused to display process shape data.

FIG. 12 is a schematic block diagram of a functional configuration of a numerical control device according to a fourth embodiment.

FIG. 13 is a diagram of an example of a machining program according to the fourth embodiment.

FIG. 14 is a flowchart for explaining an example of a procedure of display processing for a machining shape figure according to the fourth embodiment.

FIG. 15 is a diagram of an example of a state in which the machining program according to the fourth embodiment is caused to display process shape data.

FIG. 16 is a diagram of an example of a state in which a machining program according to a fifth embodiment is caused to display process shape data.

FIG. 17 is a schematic block diagram of a functional configuration of a numerical control device according to a sixth embodiment.

FIG. 18 is a diagram of an example of a state in which a machining program according to the sixth embodiment is caused to display process shape data.

FIG. 19 is a diagram of an example of a state in which a machining program according to a seventh embodiment is caused to display machining shape data.

### DESCRIPTION OF EMBODIMENTS

Preferred embodiments of a numerical control device according to the present invention are explained in detail below with reference to the accompanying drawings. The present invention is not limited by the embodiments.

### First Embodiment

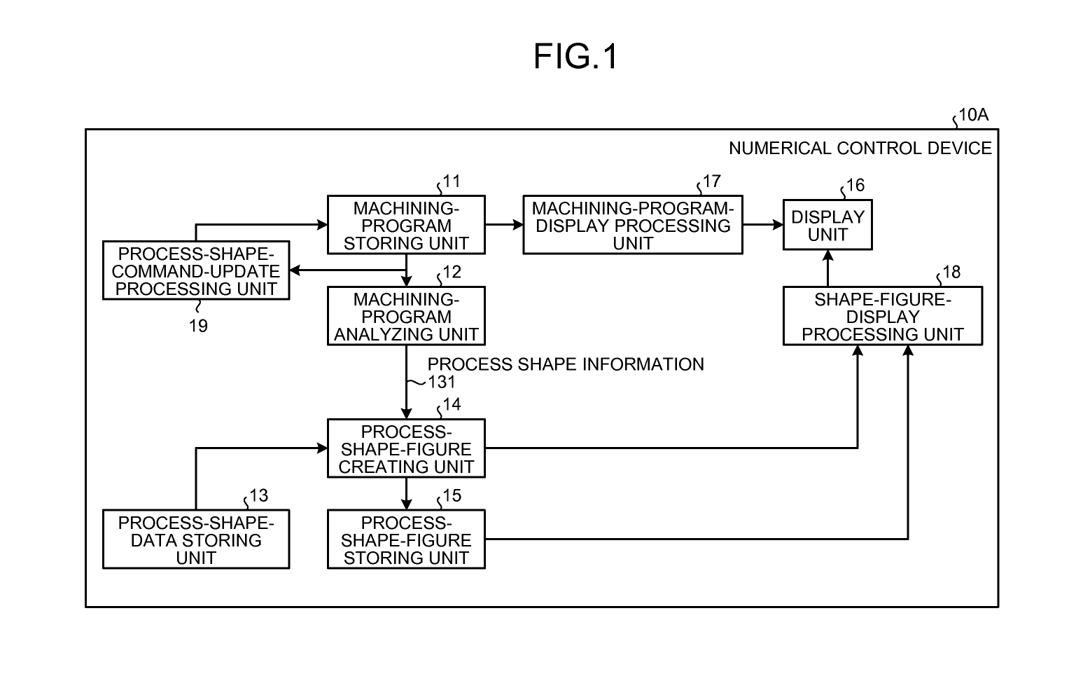

FIG. 1 is a schematic block diagram of a functional configuration of a numerical control device according to a first embodiment. A numerical control device 10A includes a machining-program storing unit 11, a machining-program analyzing unit 12, a process-shape-data storing unit 13, a process-shape-figure creating unit 14, a process-shape-figure storing unit 15, a display unit 16, a machining-program-display processing unit 17, a shape-figure-display processing unit 18, and a process-shape-command-update processing unit 19.

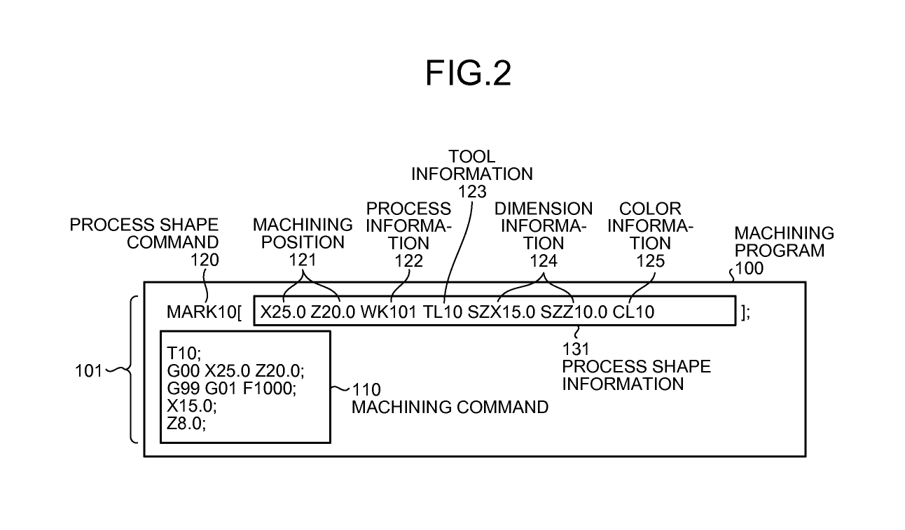

The machining-program storing unit 11 stores a machining program. FIG. 2 is a diagram of an example of the machining program according to the first embodiment. A machining program 100 includes one or more unit machining programs 101. The unit machining programs 101 are provided, for example, for each tool in use. The unit machining program 101 includes, in addition to a normal machining command 110, a process shape command 120, which is information for displaying, as a figure, a shape formed by executing the machining command 110 (hereinafter referred to as process shape). The process shape command 120 includes a machining position 121 indicating a position to be processed (e.g., a machining start position) in a coordinate system set based on a movement axis and a rotation axis of a stage on which a tool, which is a control target of the numerical control device 10A, and a machining target are placed, process information 122 indicating a final shape of the machining target formed by the execution of the machining command 110, tool information 123 indicating a tool used according to the machining command 110, dimension information 124 indicating a dimension of a machined area of the machining target, and color information 125 indicating a color of the machined area. The process shape command 120 describes the machining position 121, the process information 122, the tool information 123, the dimension information 124, and the like based on the machining command for performing actual machining. As the machining program 100, a machining program read by a not-shown machining-program reading unit via a portable information storage medium such as a memory card or a network or a machining program created by a not-shown editing unit is stored in the machining-program storing unit 11.

The machining-program analyzing unit 12 analyzes the machining program 100 acquired from the machining-program storing unit 11. When the described process shape command 120 is present in the machining program 100, the machining-program analyzing unit 12 outputs process shape information 131 obtained by analyzing the process shape command 120 to the process-shape-figure creating unit 14. This is performed in a unit of the unit machining program 101. The process shape information 131 is the same as contents included in the process shape command 120 shown in FIG. 2.

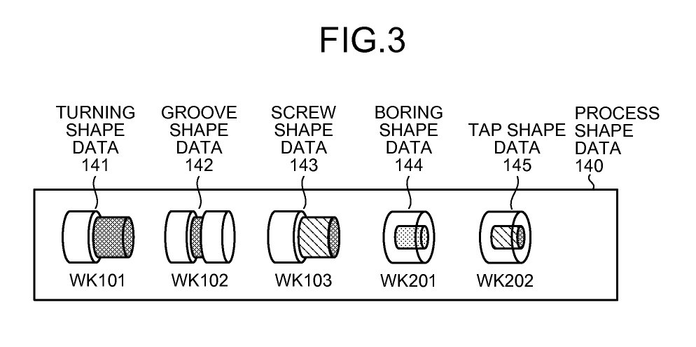

The process-shape-data storing unit 13 stores process shape data 140 corresponding to the process information 122 of the process shape information 131. FIG. 3 is a diagram of an example of process shape data. The process shape data 140 is, for example, image display of a machining shape machined by the execution of the unit machining program 101. The process shape data 140 corresponds to the process information 122 in the process shape command 120 in a one-to-one relation. In the example shown in FIG. 3, process information “WK101” corresponds to turning shape data 141, process information “WK102” corresponds to groove shape data 142, process information “WK103” corresponds to screw shape data 143, process information “WK201” corresponds to boring shape data 144, and process information “WK202” corresponds to tap shape data 145. This is only an example. A plurality of process shape data 140 is present in association with the process information 122.

The process-shape-figure creating unit 14 acquires, from the process-shape-data storing unit 13, the process shape data 140 corresponding to the process information 122 of the process shape information 131 and creates a process shape figure according to the process shape information 131. For example, the process-shape-figure creating unit 14 acquires the process shape data 140 corresponding to the process information 122 from the process-shape-data storing unit 13, corrects the process shape data 140 by using the machining position 121, the tool information 123, the dimension information 124, the color information 125, and the like specified by the process shape information 131 and creates a process shape figure.

The display unit 16 is configured by a liquid crystal display device or the like. The display unit 16 displays information such as a program and a process shape figure related to the control by the numerical control device 10A. The machining-program-display processing unit 17 displays the machining program 100 acquired from the machining-program storing unit 11 on the display unit 16.

The shape-figure-display processing unit 18 displays the process shape figure created by the process-shape-figure creating unit 14 on the display unit 16 while aligning the process shape figure with a display position of the process shape command 120 in the machining program displayed by the machining-program-display processing unit 17. At this point, the shape-figure-display processing unit 18 displays the process shape figure to be displayed while reducing or enlarging the process shape figure according to, for example, the size of displayed characters of the machining program 100 displayed on the display unit 16. The shape-figure-display processing unit 18 can display a process shape figure stored in the process-shape-figure storing unit 15 on the display unit 16 in the same manner.

Even if a fixed cycle command, which is a program for causing the numerical control device 10A to operate in a predetermined machining pattern registered in advance in the numerical control device 10A, is provided instead of the process shape command 120, if the process shape data 140 corresponding to the fixed cycle command is stored in the process-shape-data storing unit 13, the process-shape-figure creating unit 14 can acquire the process shape data 140 from the process-shape-data storing unit 13 and create a process shape figure.

The process-shape-command-update processing unit 19 has a function of updating the process shape command 120 according to the machining command 110 in the unit machining program 101 acquired from the machining-program storing unit 11. That is, the process-shape-command-update processing unit 19 analyzes the machining command 110 described in the unit machining program 101 and updates the machining position 121, the process information 122, the tool information 123, and the dimension information 124 in the process shape information 131. This means that, for example, when a user changes only the machining command 110 in the unit machining program 101, the process shape command 120 and the machining command 110 in the unit machining program 101 are different. As a result, a machining shape of a machining target machined by executing the machining command 110 and a process shape figure created using the process shape command 120 are different. To prevent such a situation, the process-shape-command-update processing unit 19 updates contents of the process shape command 120 in the unit machining program 101 to coincide with contents of the machining command 110. Such update processing is desirably executed, for example, before creation processing for a process shape figure.

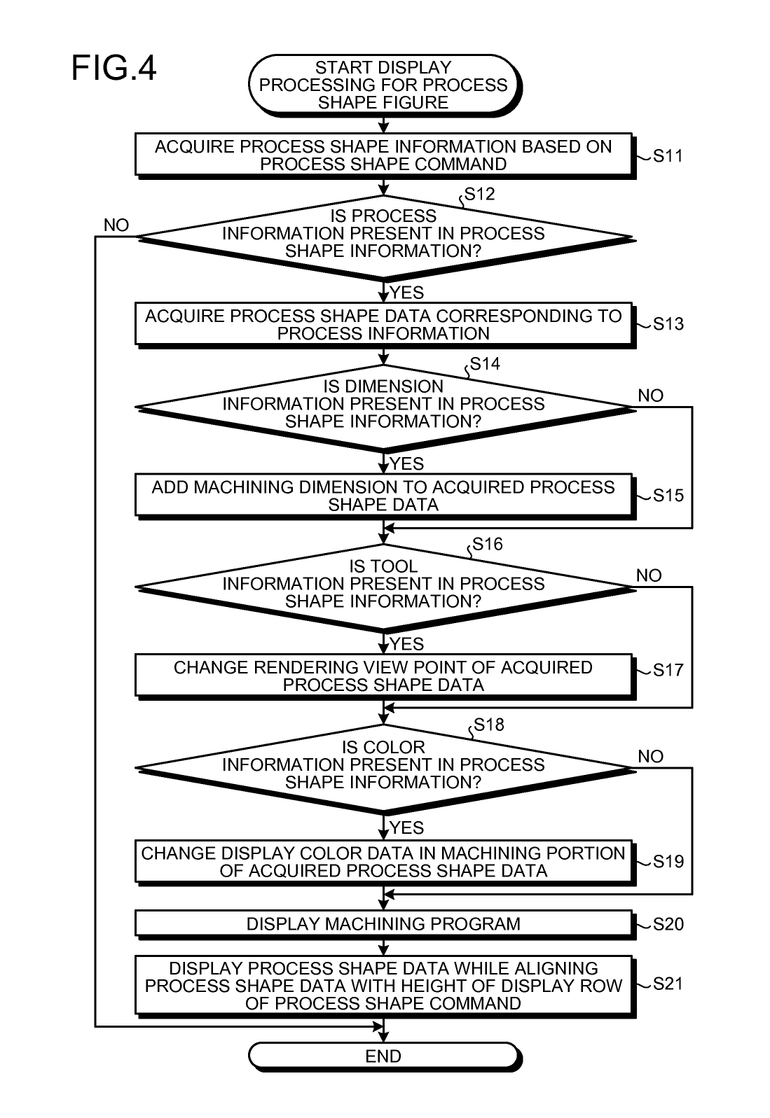

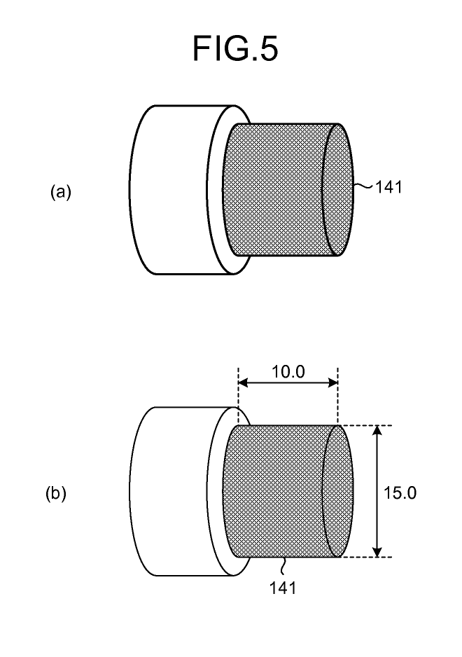

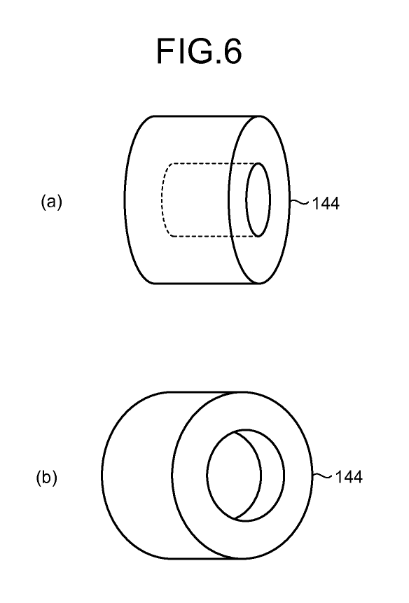

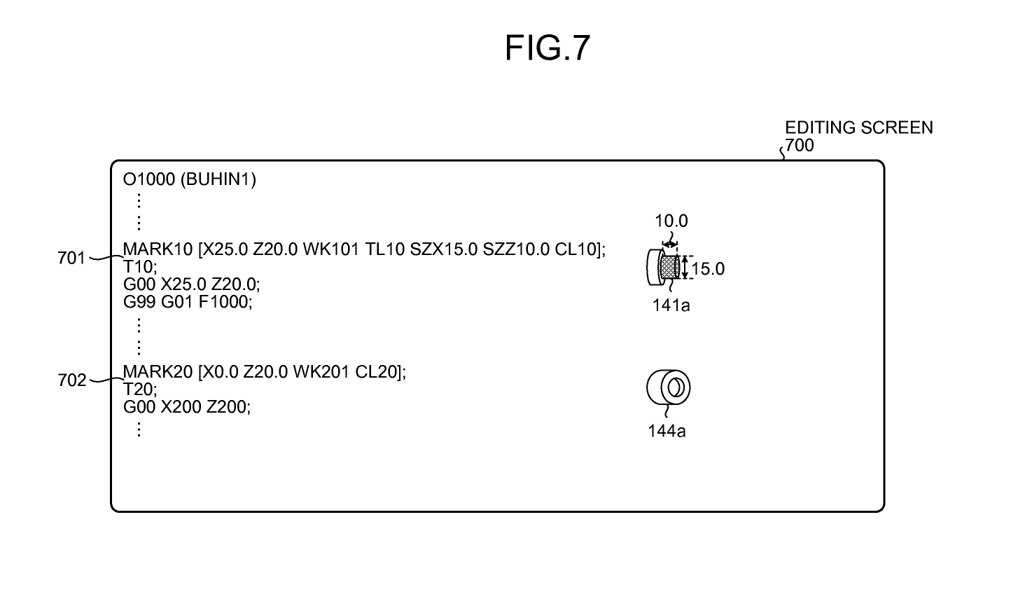

Display processing for a process shape figure in the numerical control device 10A having such a configuration is explained. FIG. 4 is a flowchart for explaining an example of the display processing procedure for a process shape figure according to the first embodiment. FIG. 5 is a diagram of an example of process shape data processed in the first embodiment. FIG. 6 is a schematic diagram of an example of processing for changing a rendering view point of the process shape data. FIG. 7 is a diagram of an example of a state in which a machining program is caused to display the process shape data.

First, the machining-program analyzing unit 12 reads out the machining program 100 from the machining-program storing unit 11, analyzes the process shape command 120 described in the unit machining program 101 of the machining program 100, and generates the process shape information 131. Subsequently, the process-shape figure creating unit 14 acquires the process shape information 131 from the machining-program analyzing unit 12 (step S11).

Thereafter, the process-shape-figure creating unit 14 determines whether the process information 122 is included in the acquired process shape information 131 (step S12). When the process information 122 is not included in the process shape information 131 (No at step S12), the process-shape-figure creating unit 14 ends the display processing for a process shape figure without creating a process shape figure. This is because a process shape figure cannot be created unless the process information 122 is present.

On the other hand, when the process information 122 is included in the process shape information 131 (Yes at step S12), the process-shape-figure creating unit 14 acquires the process shape data 140 corresponding to the process information 122 from the process-shape-data storing unit 13 (step S13). For example, in the example shown in FIG. 2, the process information 122 in the process shape information 131 is “WK101”. Process shape data corresponding to the process information 122 is the turning shape data 141 according to FIG. 3. As a result, the process-shape-figure creating unit 14 acquires the turning shape data 141 from the process-shape-data storing unit 13 as process shape data. FIG. 5(a) shows the acquired turning shape data 141.

Subsequently, the process-shape-figure creating unit 14 determines whether the dimension information 124 is included in the process shape information 131 (step S14). When the dimension information 124 is included in the process shape information 131 (Yes at step S14), the process-shape-figure creating unit 14 adds dimension data to a machining portion of the process shape data (step S15). In FIG. 5(b), the dimension data (dimension information) is added to the turning shape data 141 acquired in FIG. 5(a).

Thereafter or when the dimension information 124 is not included in the process shape information 131 at step S14 (No at step S14), the process-shape-figure creating unit 14 determines whether the tool information 123 is included in the process shape information 131 (step S16). When the tool information 123 is included in the process shape information 131 (Yes at step S16), the process-shape-figure creating unit 14 changes a rendering view point of the process shape data acquired at step S13 according to the tool information 123 (step S17). For example, when the process shape data is the turning shape data 141, it is possible to understand from a figure drawn in FIG. 3 what kind of machining is performed. On the other hand, when the process shape data is the boring shape data 144, it is not easy from a figure of the boring shape data 144 in FIG. 6(a) what kind of machining is performed. Therefore, as shown in FIG. 6(b), processing for changing a rendering view angle of the boring shape data 144 to an angle for allowing the user to see that a columnar hole is opened in one bottom surface of a columnar machining target. In this changing processing for the rendering view angle, an angle for rotating the boring shape data 144 can be determined in advance according to the tool information 123.

Thereafter or when the tool information 123 is not included in the process shape information 131 at step S16 (No at step S16), the process-shape-figure creating unit 14 determines whether the color information 125 is included in the process shape information 131 (step S18). When the color information 125 is included in the process shape information 131 (Yes at step S18), the process-shape-figure creating unit 14 changes display color data of the machining portion of the process shape data based on the color information (step S19). Consequently, a process shape figure is created from the process shape data.

Thereafter or when the color information 125 is not included at step S18 (No at step S18), the process-shape-figure creating unit 14 causes the machining-program-display processing unit 17 to display the corresponding machining program 100 on the display unit 16 (step S20). Thereafter, the shape-figure-display processing unit 18 displays, as a process shape figure, the process shape data acquired or the process shape data changed in the steps explained above while aligning the display with the height of a display row of the process shape command 120 of the machining program displayed at step S20 (step S21).

As shown in FIG. 7, for example, in a row 701, a process shape command concerning a unit machining program starting from MARK10 is displayed. On the right side of the process shape command, a display dimension change process shape FIG. 141a obtained by changing (reducing or enlarging), according to the height of the row 701, a dimension of the turning shape data 141 corresponding to process information “WK101” and added with dimension information and the like is displayed.

In a row 702 of FIG. 7, a process shape command concerning a unit machining program starting from MARK20 is displayed. On the right side of the process shape command, the display dimension change process shape FIG. 141a obtained by changing (reducing or enlarging), according to the height of the row 702, a dimension of the boring shape data 144 corresponding to process information “WK201”, added with dimension information and the like, and a rendering view angle of which is changed as shown in FIG. 6 is displayed. Consequently, the display processing for a process shape figure ends.

In the example explained above, the process shape data is three-dimensional process shape data. However, the process shape data can be two-dimensional process shape data. The process shape figure created by the process-shape-figure creating unit 14 can be stored in the process-shape-figure storing unit 15 in association with the process shape command 120. Consequently, it is possible to display the process shape figure stored in the process-shape-figure storing unit 15 on the display unit 16 without creating a process shape figure using the process-shape-figure creating unit 14 every time an editing screen is displayed.

In the first embodiment, the process shape data 140 corresponding to the process information 122 in the process shape command 120 is prepared in advance, the process shape data 140 is changed according to the information in the process shape command 120, and, when the machining program 100 is displayed, the changed process shape figure is displayed to match the size of a display row of the process shape command 120. As a result, there is an effect that it is unnecessary to capture image data in advance for each machining program 100 (unit machining program 101), it does not take labor and time for creation and registration of image data, and, even when machining program contents are changed, it is unnecessary to capture image data again. Because a machining simulation corresponding to the machining program 100 is not performed, it is possible to reduce time required for displaying a machining shape and machining program information concerning the machining simulation compared with the related art. Consequently, it is possible to select, prior to actual machining, a machining program necessary for the actual machining out of a plurality of machining programs incorporated in the numerical control device and check machining contents.

### Second Embodiment

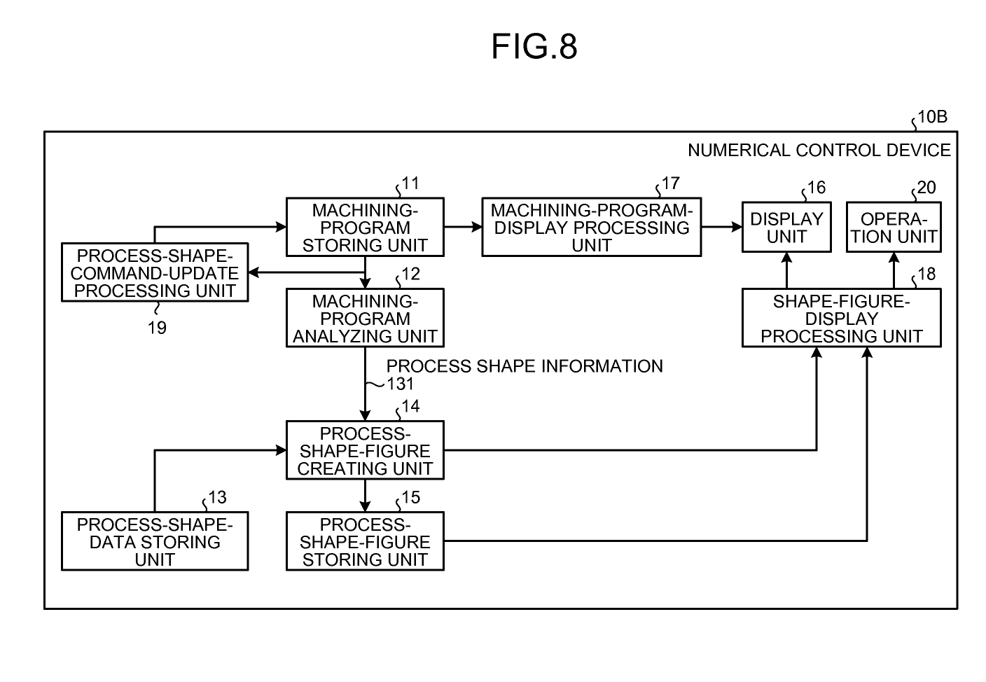

FIG. 8 is a schematic block diagram of a functional configuration of a numerical control device according to a second embodiment. A numerical control device 10B according to the second embodiment further includes, in the numerical control device 10A according to the first embodiment, an operation unit 20 for giving instructions for display, execution, and like of a machining program from a user to the numerical control device 10B.

The machining-program-display processing unit 17 further includes a function of acquiring, when a machining program is displayed on the display unit 16, the present position of a cursor in a machining program input from the operation unit 20 and passing a result of the acquisition of the position (position information of the cursor and a process shape command corresponding thereto) to the shape-figure-display processing unit 18. At this point, for example, when the position of the cursor is present in the position of the process shape command, the machining-program-display processing unit 17 can notify the shape-figure-display processing unit 18 of a process shape command corresponding to the position information of the cursor.

The shape-figure-display processing unit 18 further includes a function of displaying, when the cursor position acquired from the machining-program-display processing unit 17 is present in a display row of the process shape command of the machining program, an enlarged process shape figure obtained by enlarging a process shape figure created based on the process shape command by the process-shape-figure creating unit 14 on the display unit 16.

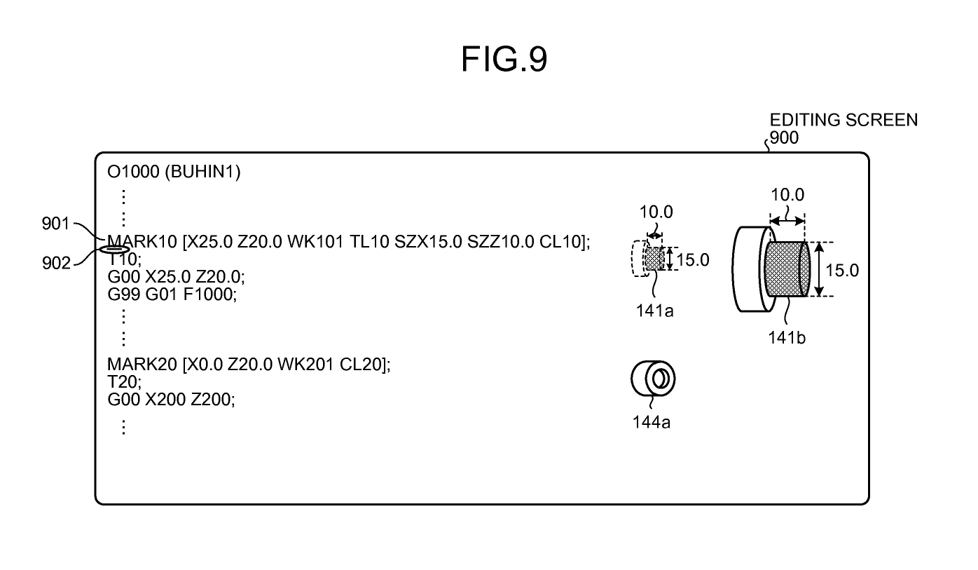

FIG. 9 is a diagram of an example of a state in which a machining program according to the second embodiment is caused to display process shape data. On an editing screen 900 in the second embodiment, a cursor 902 is placed in a row 901 by the operation unit 20. The row 901 is the position of a process shape command of a unit machining program. Therefore, the machining-program-display processing unit 17 notifies the present position of the cursor 902 and the process shape command present in the position of the cursor 902.

The shape-figure-display processing unit 18 generates an enlarged process shape FIG. 141b obtained by enlarging a process shape figure corresponding to the process shape command, on which the cursor 902 is present, and displays the enlarged process shape FIG. 141b, for example, on the right side of the process shape command present in the position of the cursor 902. At this point, the display dimension change process shape FIG. 141a displayed according to the height of the row 901 can be displayed or does not have to be displayed. While the enlarged process shape FIG. 141b is displayed, the display dimension change process shape FIG. 141a can be displayed dimly or flashed. Note that components same as the components in the first embodiment are denoted by the same reference numerals and signs and explanation of the components is omitted. The operation of the numerical control device 10B is also the same as the operation in the first embodiment. Therefore, explanation of the operation is omitted.

In the second embodiment, when a cursor operation by the operation unit 20 is located in a row of a process shape command in a machining program, a process shape figure corresponding to the process shape command is displayed in enlargement. Consequently, there is an effect that it is possible to easily check a shape machined by the machining program compared with the case of the first embodiment.

### Third Embodiment

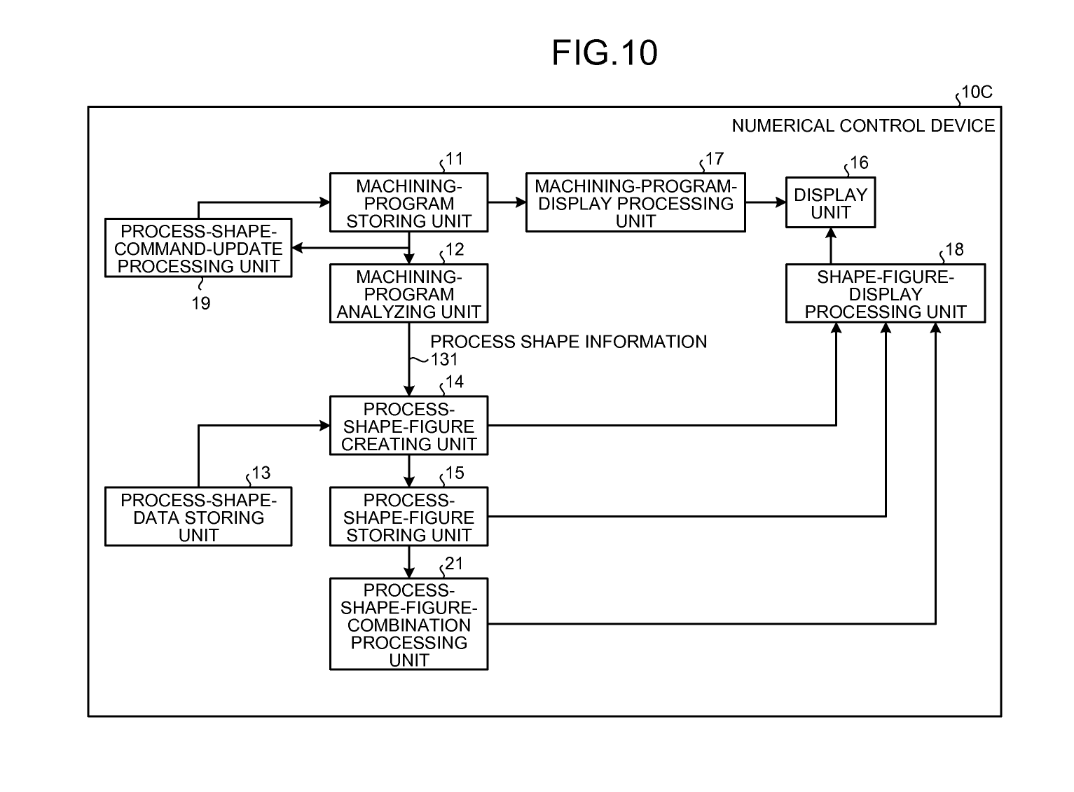

FIG. 10 is a schematic block diagram of a functional configuration of a numerical control device according to a third embodiment. A numerical control device 10C according to the third embodiment further includes, in the numerical control device 10A according to the first embodiment, a process-shape-figure-combination processing unit 21 configured to combine, using a process shape figure created according to a process shape command of the present process and a process shape figure created according to a process shape command of the preceding process, the process shape figures of the two (a plurality of) processes and create a process shape figure obtained by executing the two (the plurality of) processes.

Specifically, the process-shape-figure-combination processing unit 21 combines a process shape figure of the present process created by the process-shape-figure creating unit 14 based on a process shape command of the present process (unit machining program) with a process shape figure of the preceding process created based on a process shape command of the preceding process (unit machining program) and stored in the process-shape-figure storing unit 15 and creates a combined process shape figure. At this point, the process-shape-figure-combination processing unit 21 performs superimposition of the two process shape figures according to a machining position in the process shape command of the preceding process and a machining position in the process shape command of the present process.

When storing the process shape figure in the process-shape-figure storing unit 15, the process-shape-figure creating unit 14 stores the process shape figure in association with the process shape command. Further, the shape-figure-display processing unit 18 displays the combined process shape figure created by the process-shape-figure-combination processing unit 21 on the display unit 16.

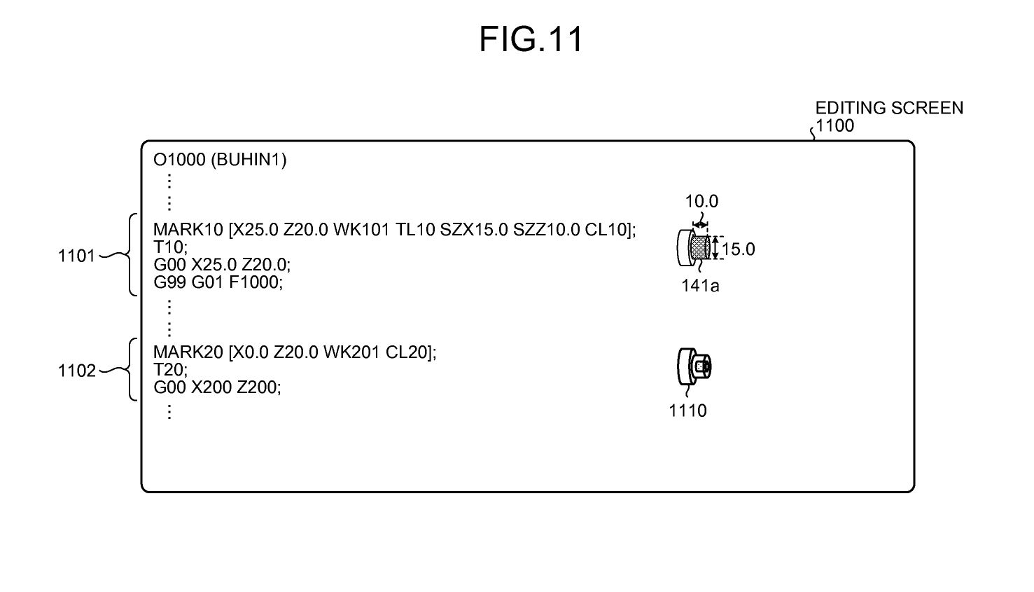

FIG. 11 is a diagram of an example of a state in which a machining program according to the third embodiment is caused to display process shape data. On an editing screen 1100 in the third embodiment, the display dimension change process shape FIG. 141a formed according to a process shape command of a unit machining program 1101, which is the preceding process, is displayed on the right side of a row of a process shape command of the preceding process. On the right side of a process shape command of a unit machining program 1102, which is the present process, a combined process shape FIG. 1110 obtained by combining the display dimension change process shape FIG. 141a formed according to the process shape command of the preceding process and a process shape figure formed according to the process shape command of the present process is displayed. In this way, in the third embodiment, a result of machining processing performed in the present process is displayed while being superimposed on a result of machining processing performed in the preceding process.

Components same as the components in the first embodiment are denoted by the same reference numerals and explanation of the components is omitted. The operation of the numerical control device 10C is also the same as the operation in the first embodiment. Therefore, explanation of the operation is omitted. Further, in the above explanation, the process-shape-figure-combination processing unit 21 is provided in the numerical control device 10A according to the first embodiment. However, in the above explanation, the process-shape-figure-combination processing unit 21 can be provided in the numerical control device 10B according to the second embodiment.

In the above explanation, the two process shape figures of the preceding process and the present process are combined. However, if process shape figures of three or more processes are stored in the process-shape-figure storing unit 15 in association with the process shape command 120, it is also possible to display a combined process shape figure obtained by a plurality of process shape figures using the process-shape-figure-combination processing unit 21 on the display unit 16.

According to the third embodiment, there is an effect that it is possible to accumulate and display results of a plurality of kinds of processing performed by the machining program.

### Fourth Embodiment

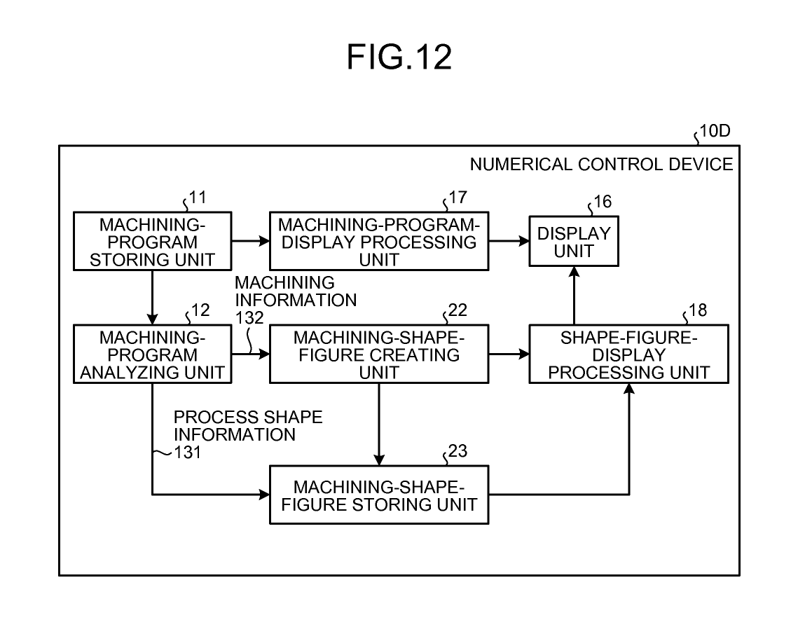

FIG. 12 is a schematic block diagram of a functional configuration of a numerical control device according to a fourth embodiment. A numerical control device 10D according to the fourth embodiment includes the machining-program storing unit 11, the machining-program analyzing unit 12, the display unit 16, the machining-program-display processing unit 17, the shape-figure-display processing unit 18, the process-shape-command-update processing unit 19, a machining-shape-figure creating unit 22, and a machining-shape-figure storing unit 23.

The machining-shape-figure creating unit 22 performs a simulation according to machining information 132 output from the machining-program analyzing unit 12 and creates a machining shape figure. The machining information 132 refers to a machining command. The machining shape figure refers to figure information of a machining target obtained as a result of processing the machining target according to a machining command of a machining program. When shape storage information is included in the process shape information 131, the machining-shape-figure creating unit 22 stores, in the machining-shape-figure storing unit 23, a machining shape figure of a result obtained by simulating up to a machining command corresponding to a process shape command of the process shape information 131. At this point, the machining-shape-figure creating unit 22 stores the machining shape figure in association with the process shape command including the shape storage information.

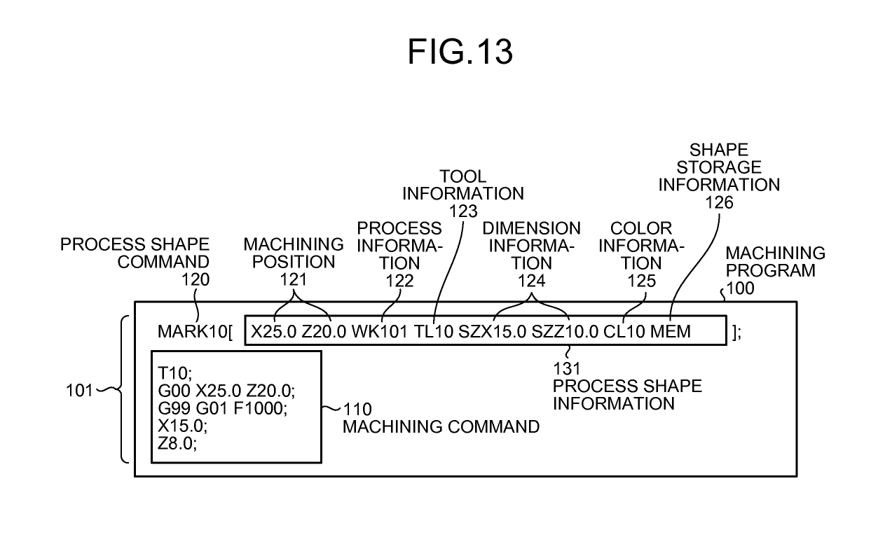

FIG. 13 is a diagram of an example of a machining program according to the forth embodiment. In the fourth embodiment, the process shape command 120 of the unit machining program 101 in the machining program 100 includes shape storage information 126 for specifying, when the machining program 100 is simulated, whether a shape, which is a result obtained by executing up to the machining command 110 of the unit machining program 101, is stored. For example, when “MEM” is described in the shape storage information 126, a machining shape figure obtained as a result of executing up to the unit machining program 101 indicated by MARK10 is stored in the machining-shape-figure storing unit 23. When nothing is described in the shape storage information 126 (when the shape storage information 126 is absent), the machining shape figure obtained as a result of executing up to the unit machining program 101 indicated by the MARK10 is not stored in the machining-shape-figure storing unit 23.

When the shape storage information 126 is included in the process shape information 131, the machining-shape figure storing unit 23 stores a machining shape figure obtained by simulating up to the unit machining program 101 of the machining program 100 corresponding to the process shape command 120 of the process shape information 131. The machining shape figure is stored in association with the process shape command 120 including the shape storage information 126.

In the fourth embodiment, the machining-program analyzing unit 12 includes a function of outputting the machining information 132 obtained by analyzing the machining command 110 described in the unit machining program 101 to the machining-shape-figure creating unit 22 and outputting the process shape information 131 to the machining-shape-figure storing unit 23.

The shape-figure-display processing unit 18 displays, on the display unit 16, a display dimension changed machining shape figure obtained by reducing or enlarging the process shape figure stored in the machining-shape-figure storing unit 23 while aligning the machining shape figure with a display position of the corresponding process shape command 120 in the machining program, which is displayed on the display unit 16 by the machining-program-display processing unit 17, and according to the size of display characters. Components same as the components in the first embodiment are denoted by the same reference numerals and signs and explanation of the components is omitted.

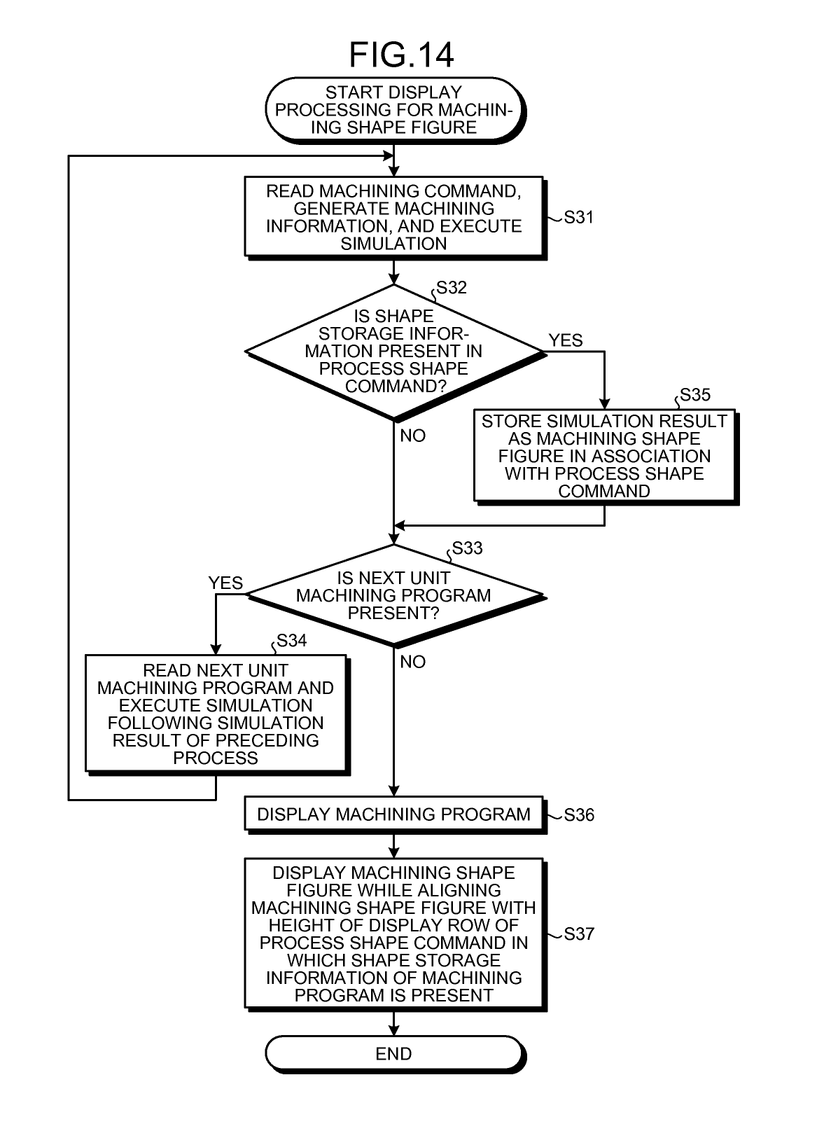

Display processing for a machining shape figure in the numerical control device 10D having such a configuration is explained. FIG. 14 is a flowchart for explaining an example of a procedure of the display processing for a machining shape figure according to the fourth embodiment.

First, the machining-program analyzing unit 12 reads out the machining program 100 from the machining-program storing unit 11, analyzes the machining command 110 described in the unit machining program 101 in the machining program 100, and generates machining information. Subsequently, the machining-shape figure creating unit 22 acquires the machining information from the machining-program analyzing unit 12 and executes a simulation (step S31).

Subsequently, the machining-program analyzing unit 12 analyzes the process shape command 120 described in the read unit machining program 101 and determines whether the shape storage information 126 is present in the process shape command 120 (step S32). When the shape storage information 126 is absent (No at step S32), the machining-program analyzing unit 12 determines whether the next unit machining program 101 is present in the machining program 100 (step S33). When the next unit machining program 101 is present (Yes at step S33), the machining-program analyzing unit 12 reads the next unit machining program and executes a simulation following a simulation result in the preceding process (step S34). Thereafter, the processing returns to step S31.

When the shape storage information 126 is present at step S32 (Yes at step S32), the machining-shape-figure creating unit 22 stores results of the simulations executed so far in the machining-shape-figure storing unit 23 as a machining shape figure in association with the process shape command 120 (step S35). Thereafter, the processing shifts to step S33.

When the next unit machining program 101 is absent at step S33 (No at step S33), the machining-program-display processing unit 17 displays the machining program 100 on the display unit 16 (step S36). The shape-figure-display processing unit 18 displays, adjacent to a display row of the process shape command 120 in which the shape storage information 126 is present, a machining shape figure, which is a simulation result of the corresponding machining program 100 (step S37). At this point, a machining shape figure, which is a simulation result of the entire machining program 100 created by the machining-shape-figure creating unit 22, is displayed adjacent to a display row of the process shape command 120 of the last unit machining program 101. The machining shape figure stored in the machining-shape-figure storing unit 23 is displayed adjacent to a display row of the process shape command 120 associated with the machining shape figure. These machining shape figures are displayed on the display unit 16 as a display dimension changed machining shape figure, the dimension of which is changed to match the height of a display row of the process shape command 120. Consequently, the display processing for a machining shape figure ends.

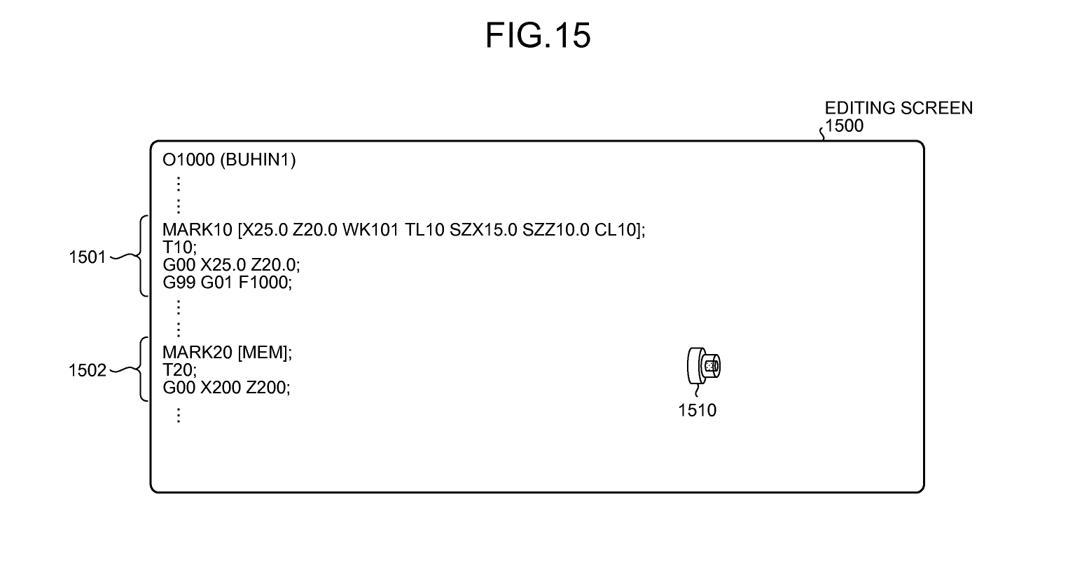

FIG. 15 is a diagram of an example of a state in which a machining program according to the fourth embodiment is caused to display process shape data. In an editing screen 1500 in the fourth embodiment, a process shape command of a unit machining program 1501 does not include the shape storage information 126 and a process shape command of a unit machining program 1502 includes the shape storage information 126. Therefore, a simulation result based on information concerning machining performed up to the unit machining program 1501 is not displayed on the right side of the process shape command of the unit machining program 1501. On the other hand, a machining shape FIG. 1510, which is a simulation result based on information concerning machining performed up to the unit machining program 1502, is displayed on the right side of the process shape command of the unit machining program 1502. At this point, the size of the machining shape FIG. 1510 is changed to match the size of a display row of the process shape command of the unit machining program 1502.

In the related art, when a simulation is performed based on the machining program 100, a machining shape figure, which is a result obtained by simulating all the unit machining programs 101 in the machining program 100, is only obtained. However, according to the fourth embodiment, because the shape storage information 126 is added to the process shape command 120 in the unit machining program 101, it is possible to store a machining shape figure, which is a simulation result up to a position where the shape storage information 126 is added and display the machining shape figure in a display row of the corresponding process shape command 120 of the unit machining program 101. As a result, there is an effect that it is possible to grasp a machining shape figure of a machining target halfway in one machining program 100.

### Fifth Embodiment

A numerical control device according to a fifth embodiment further includes, in the numerical control device 10D according to the fourth embodiment, a function in which the machining-program-display processing unit 17 acquires machining program numbers and comments of a machining program stored in the machining-program storing unit 11 and causes the display unit 16 to display the machining program numbers and the comments in a list format.

The machining-shape-figure creating unit 22 creates a machining shape figure according to the machining information 132, which is an analysis result of a machining command acquired from the machining-program analyzing unit 12. The creation of a machining shape figure is executed for each machining program number of a machining program.

Further, the shape-figure-display processing unit 18 includes a function of displaying, on the display unit 16, a display dimension changed machining shape figure obtained by reducing or enlarging the process shape figure created by the machining-shape-figure creating unit 22 while aligning the machining shape figure with a display position of a program number of a machining program displayed on the display unit 16. The other components are the same as the components in the fourth embodiment.

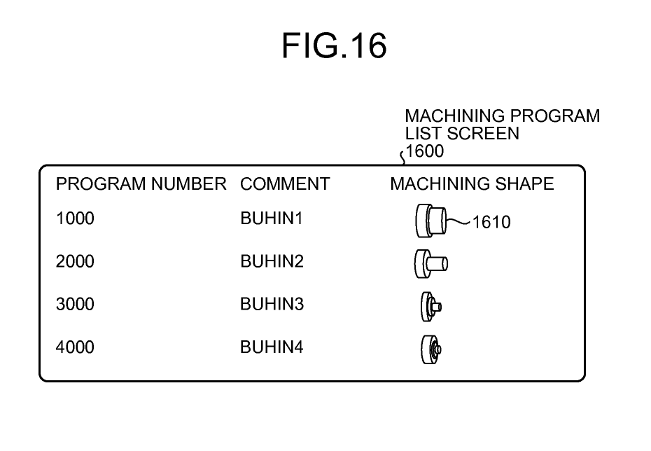

FIG. 16 is a diagram of an example of a state in which a machining program according to the fifth embodiment is caused to display process shape data. As shown in the figure, on a machining program list screen 1600, machining program numbers and comments extracted by the machining-program-display processing unit 17 are displayed on the display unit 16 in a list format. Machining shape FIG. 1610 corresponding to machining program numbers are displayed on the right side of corresponding rows of the machining program numbers on the display unit 16.

The machining shape FIG. 1610 created by the machining-shape-figure creating unit 22 can be stored in the machining-shape-figure storing unit 23 in association with a machining program. Consequently, the shape-figure-display processing unit 18 can read out the machining shape FIG. 1610 stored in the machining-shape-figure storing unit 23 and display the machining shape FIG. 1610 on the display unit 16 without creating the machining shape FIG. 1610 using the machining-shape-figure creating unit 22 every time the machining program list screen 1600 is displayed.

According to the fifth embodiment, it is possible to display, in a list format, machining shapes of machining targets obtained when machining programs corresponding to machining program numbers are executed. Therefore, it is possible to facilitate identification of a machining program by a user. As a result, it is possible to improve work efficiency for selecting a machining program when the machining program is operated or when the machining program is edited.

### Sixth Embodiment

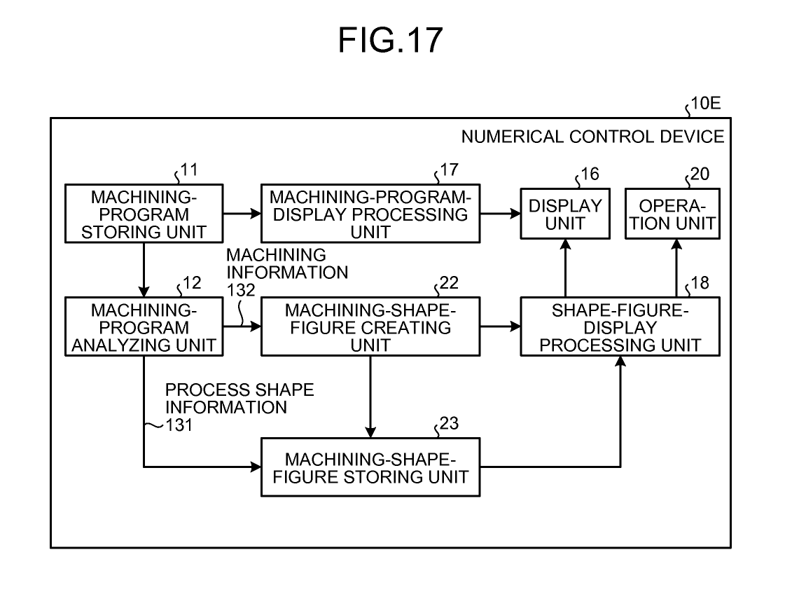

FIG. 17 is a schematic block diagram of a functional configuration of a numerical control device according to a sixth embodiment. A numerical control device 10E according to the sixth embodiment further includes, in the numerical control device 10D according to the fourth embodiment, the operation unit 20 for giving instructions for display, execution, and like of a machining program from a user to the numerical control device 10E.

When machining programs are displayed as a list on the display unit 16, the machining-program-display processing unit 17 acquires the present position of a cursor in the list input from the operation unit 20 and passes a result of the acquisition to the shape-figure-display processing unit 18.

When the cursor position acquired from the machining-program-display processing unit 17 is present in a position of the machining program list displayed by the machining-program-display processing unit 17, the shape-figure-display processing unit 18 displays, in a position on the display unit 16 corresponding to a display row of a machining program number on which the cursor position is present, an enlarged process shape figure obtained by enlarging a process shape figure corresponding to the machining program number.

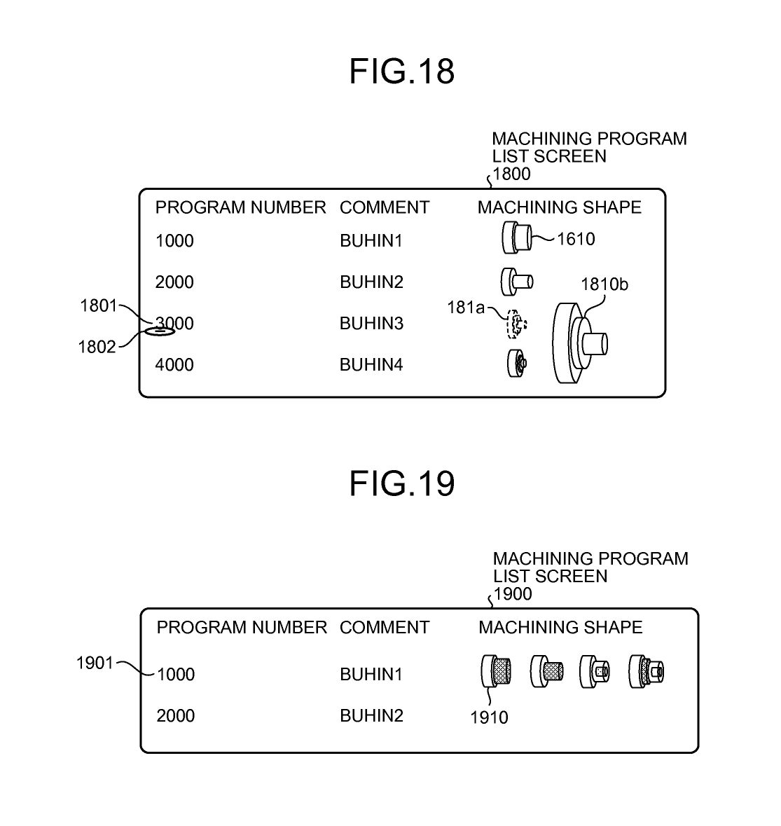

FIG. 18 is a diagram of an example of a state in which a machining program according to the sixth embodiment is caused to display process shape data. A cursor 1802 is placed on a row 1801 by the operation unit 20. The row 1801 is the position of a machining program number “3000”. Therefore, the machining-program-display processing unit 17 notifies the present position of the cursor 1802 and the machining program number “3000” present in the position of the cursor 1802. The shape-figure-display processing unit 18 displays, on the right side of the machining program number present in the position of the cursor 1802, an enlarged machining shape FIG. 1810b obtained by enlarging a machining shape FIG. 1810 corresponding to the machining program number on which the cursor 1802 is present. Note that components same as the components in the fourth embodiment are denoted by the same reference numerals and signs and explanation of the components is omitted.

According to the sixth embodiment, when the cursor operated by the operation unit 20 is located in a certain row in the list of the machining programs, a machining shape figure corresponding to a machining program number of the machining program is displayed in enlargement. Consequently, there is an effect that it is possible to easily check a shape to be machined by the machining program.

### Seventh Embodiment

A numerical control device according to a seventh embodiment includes, in the numerical control device 10E according to the fifth embodiment, a function in which the shape-figure-display processing unit 18 displays, according to a plurality of process shape commands 120 described in a machining program, a display dimension changed machining shape figure obtained by changing dimensions of a plurality of machining shape figures created by the machining-shape-figure creating unit 22. At this point, the shape-figure-display processing unit 18 displays a plurality of display dimension changed machining shape figures in areas of machining program numbers corresponding thereto in order in time series. The machining shape figures to be displayed are machining shape information corresponding to a process shape command including shape storage information. These kinds of machining shape information only have to be displayed in order. Note that the other components are the same as the components in the fifth embodiment.

Alternatively, the numerical control device according to the seventh embodiment can also be manufactured based on the numerical control device 10C according to the third embodiment. That is, the numerical control device according to the seventh embodiment further includes, in the numerical control device 10C according to the third embodiment, a function in which the machining-program-display processing unit 17 acquires machining program numbers and comments of machining programs stored in the machining-program storing unit 11 and causes the display unit 16 to display the machining program numbers and the comments in a list format. The process-shape-figure-combination processing unit 21 acquires process shape figures in a plurality of processes created by the process-shape-figure creating unit 14, creates a combined process shape figure obtained by combining the process shape figures, and stores the combined process shape figure in the process-shape-figure storing unit 15. The shape-figure-display processing unit 18 has a function of displaying, on the display unit 16, in order in time series, display dimension changed combined process shape figures obtained by changing dimensions of a plurality of combined process shape figures while aligning the display dimension changed combined process shape figures with display positions of the program numbers of the machining programs, which are displayed on the display unit 16 by the machining-program-display processing unit 17, and according to the size of display characters. The other components are the same as the components in the third embodiment.

Alternatively, the numerical control device according to the seventh embodiment can also be manufactured based on the numerical control device 10A according to the first embodiment. That is, the numerical control device according to the seventh embodiment further includes, in the numerical control device 10A according to the first embodiment, a function in which the machining-program-display processing unit 17 acquires machining program numbers and comments of machining programs stored in the machining-program storing unit 11 and causes the display unit 16 to displays the machining program numbers and the comments in a list format. The numerical control device according to the seventh embodiment includes a function in which the shape-figure-display processing unit 18 acquires process shape figures in a plurality of processes created by the process-shape-figure creating unit 14 according to a plurality of process shape commands 120 described in a machining program and displays a plurality of display dimension changed process shape figures obtained by changing dimensions of the process shape figures. At this point, the shape-figure-display processing unit 18 displays, on the display unit 16, in order in time series, the display dimension changed combined process shape figures while aligning the display dimension changed combined process shape figures with display positions of the program numbers of the machining programs, which are displayed on the display unit 16 by the machining-program-display processing unit 17, and according to the size of display characters. As the process shape figures, process shape figures created by the shape-figure creating unit 14 and stored in the process-shape-figure storing unit 15 can also be used. Note that the other components are the same as the components in the first embodiment.

FIG. 19 is a diagram of an example of a state in which a machining program according to the seventh embodiment is caused to display machining shape data. As shown in the figure, in a machining program list screen 1900, machining program numbers and comments are displayed on the display unit 16 in a list format by the machining-program-display processing unit 17. Machining shape figures corresponding to the machining program numbers are displayed in time series on the right side of rows corresponding to the machining program numbers on the display unit 16 by the shape-figure-display processing unit 18. In the case of the numerical control device manufactured based on the numerical control device 10C according to the third embodiment, combined process shape figures stored in the process-shape-figure storing unit 15 corresponding to the machining program numbers are displayed in time series on the right side of rows corresponding to the machining program numbers on the display unit 16 by the shape-figure-display processing unit 18.

According to the seventh embodiment, when a machining program corresponding to a machining program number in a certain row in a list of machining programs is executed, it is displayed in time series in what kind of shape a machining target is machined. Therefore, there is an effect that a user can visually understand a change in a processing shape due to a machining program for a machining target.

### INDUSTRIAL APPLICABILITY

As explained above, the numerical control device according to the present invention is useful for selecting, prior to actual machining, an NC machining program necessary for the actual machining out of a plurality of NC machining programs incorporated in an NC machine tool and checking NC machining contents.

### REFERENCE SIGNS LIST

10A to 10E Numerical control devices
11 Machining-program storing unit
12 Machining-program analyzing unit
13 Process-shape-data storing unit
14 Process-shape-figure creating unit
15 Process-shape-figure storing unit
16 Display unit
17 Machining-program-display processing unit
18 Shape-figure-display processing unit
19 Process-shape-command-update processing unit
20 Operation unit
21 Process-shape-figure-combination processing unit
22 Machining-shape-figure creating unit
23 Machining-shape-figure storing unit
100 Machining program
101 Unit machining program
110 Machining command
120 Process shape command
121 Machining position
122 Process information
123 Tool information
124 Dimension information
125 Color information
126 Shape storage information
140 Process shape data
141 Turning shape data
142 Groove shape data
143 Screw shape data
144 Boring shape data
145 Tap shape data.

1. A numerical control device that analyzes a machining program containing one or more unit machining programs and displays a process shape figure obtained by executing the unit machining program, the numerical control device comprising:
a machining-program analyzing unit that analyzes the unit machining program in the machining program and acquires process shape information having parameters containing tool information for obtaining the process shape figure for the unit machining program;
a process-shape-figure creating unit that acquires process shape data corresponding to the tool information in the process shape information and creates the process shape figure obtained by changing the process shape data based on the parameters in the process shape information; and
a display processing unit that displays the machining program and the process shape figure on a display unit,
wherein the display processing unit displays the process shape figure that is aligned with a display position of the unit machining program of the machining program displayed on the display unit.

2. The numerical control device according to claim 1, further comprising:
a process-shape-data storing unit that stores the process shape data corresponding to the tool information,
wherein the process-shape-figure creating unit acquires the process shape data from the process-shape-data storing unit, based on the tool information in the process shape information.

3. The numerical control device according to claim 1, wherein the unit machining program includes a tool shape command containing the parameters and a machining command.

4. The numerical control device according to claim 3, further comprising:
a process-shape-figure storing unit that stores the process shape figure created by the process-shape creating unit, in association with the process shape command,
wherein the display processing unit acquires the process shape figure corresponding to the process shape command from the process-shape-figure storing unit, in reading the unit machining program for second and subsequent times, and displays the process shape figure on the display unit.

5. The numerical control device according to claim 3,
wherein the parameters have dimension information of a shape obtained by execution of the machining command, and
wherein the tool-shape-figure creating unit adds the dimension information to the process shape data and creates the process shape figure.

6. The numerical control device according to claim 3, wherein the process-shape-figure creating unit changes a rendering view point of the process shape data, based on the tool information.

7. The numerical control device according to claim 3,
wherein the parameters have color information, and
wherein the process-shape-figure creating unit creates the process shape figure obtained by changing a display color of a machining portion of the process shape data based on the color information.

8. The numerical control device according to claim 1, wherein the display processing unit changes a dimension of the process shape figure that is aligned with a display row of the process shape command of the unit machining program in the display unit, and displays the dimension.

9. The numerical control device according to claim 1, wherein the machining program is a fixed cycle command, which is a program for causing the numerical control device to operate in a predetermined machining pattern.

10. The numerical control device according to claim 1, wherein the display processing unit further includes a function of enlarging and displaying the process shape figure corresponding to the process shape command in a position where a cursor is present in the display unit.

11. The numerical control device according to claim 1, further comprising:
a process-shape-figure-combination processing unit that creates a combined process shape figure obtained by aligning and combining a present process shape figure, which is created based on present one of the unit machining programs by the process-shape-figure creating unit, with a preceding process shape figure corresponding to the unit machining program before the unit machining program corresponding to the present process shape figure,
wherein the display processing unit displays the combined process shape figure that is aligned with a position of the process shape command of the present unit machining program.

12. The numerical control device according to claim 11, further comprising:
a process-shape-figure storing unit that stores, in association with the process shape command, the combined process shape figure created by the process-shape-combination processing unit,
wherein the display processing unit further includes a function of acquiring the machining program numbers and comments from the machining program, displaying the machining program numbers and the comments on the display unit in a list format, acquiring, from the process-shape-figure storing unit, a plurality of the combined process shape figures stored in association with the machining programs corresponding to the machining program numbers, and displaying the combined process shape figures on the display unit that are aligned with display positions of the machining program numbers.

13. The numerical control device according to claim 3, further comprising a process-shape-command-update processing unit that updates the parameters in the process shape command, based on the contents of the machining command.

14. A numerical control device that analyzes a machining program containing one or more unit machining programs and displays a machining shape figure obtained by executing the unit machining program, the numerical control device comprising:
a machining-program analyzing unit that analyzes the unit machining program in the machining program and acquires process shape information containing shape storage information that indicates presence or absence of storage of the machining shape figure obtained as a result of simulating up to the unit machining program;
a machining-shape-figure creating unit that performs a simulation based on a machining command in the unit machining program and creates the machining shape figure;
a machining-shape-figure storing unit that stores the machining shape figure in association with the process shape information having the shape storage information for storing the machining shape figure; and
a display processing unit that displays the machining program and the machining shape figure on a display unit,
wherein the display processing unit displays the machining shape figure that is aligned with a display position of the unit machining program having the shape storage information in the machining program displayed on the display unit.

15. The numerical control device according to claim 14,
wherein the machining-shape-figure creating unit further includes a function of creating the machining shape figure for each machining program number of the machining program, and
wherein the display processing unit further includes a function of acquiring the machining program number and a comment from the machining program, displaying the machining program number and the comment on the display unit in a list format, and displaying on the display unit the machining shape figure that is aligned with the display position of the machining program number.

16. The numerical control device according to claim 15, wherein the display processing unit further includes a function of enlarging and displaying the machining shape figure corresponding to the machining program number on which a cursor is present in the display unit.

17. The numerical control device according to claim 15, wherein the display processing unit acquires the machining program number and the comment from the machining program, displays the machining program number and the comment on the display unit in a list format, acquires, from the machining-shape-figure storing unit, a plurality of the machining shape figures stored in association with the machining program corresponding to the machining program number, and displays the machining shape figures on the display unit that is aligned with a display position of the machining program number.
